(19) United States
(12) Patent Application Publication
(10) Pub. No.: US 2015/0155904 A1
(43) Pub. Date: Jun. 4, 2015

(54) High Gain Mobile Hotspot

(71) Applicant: BOARD OF TRUSTEES OF THE UNIVERSITY OF ARKANSAS, Little Rock, AR (US)

(72) Inventor: Mark W. Ingalls, Fayetteville, AR (US)

(21) Appl. No.: 14/559,145

(22) Filed: Dec. 3, 2014

Related U.S. Application Data
(60) Provisional application No. 61/911,459, filed on Dec. 3, 2013.

(51) Int. Cl. H04B 1/40; H04W 72/04; H04W 88/08

(52) U.S. Cl. CPC H04B 1/40; H04W 88/08; H04W 72/0453

(57) ABSTRACT

The present invention is a mobile hotspot system comprising a first bi-directional antenna operably coupled to a transceiver capable of at least demodulation, modulation, and amplification and a second omni-directional antenna operably coupled to said transceiver; an electrical power source operably coupled to said transceiver. RF interconnections between said transceiver, said first bi-directional antenna, said transceiver and said second-directional antenna are also provided. The system is housed in a compact, weather-resistant radome, and optionally includes a power source, which may be one or more of batteries, battery chargers, and power connections.

### RELATED APPLICATIONS

This application claims the benefit of U.S. Provisional Application No. 61/911,459, filed Dec. 3, 2013.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

There is a broad movement away from broadband access based on fixed infrastructure, to access based on mobile devices. For example, by the start of 2013, an estimated 56% of Americans will own a smart phone or similar device. Such smart phones are capable of providing Internet access via nearby cell phone towers. Of Americans, 10% have a smart phone but do not have a home broadband connection, meaning that the smart phone is their primary means of accessing the Internet. This number is expected to grow. However, cell phone infrastructure is largely built around population centers and along major highways. Therefore, as much as 20% of Americans currently have poor or no cell phone service. According, to an FCC 2012 report, 19 million Americans currently have no access at all. For example, 45% of the residents of West. Virginia and 35% of the residents of California do not have access at the present time.

In addition, 4G is now implemented over a growing portion of the U.S., but many people have only slower 3G access. There are many cases where access to Internet is deemed important, yet the installed infrastructure is not capable of providing high quality service. There is a need for a system that improves access without requiring further installation of dedicated, centralized resources.

Typical communication between a cell phone tower and an individual mobile device is limited by round-trip latency requirement to 35 km (21.7 miles). However, actual distance varies due to a number of factors, such as: antenna height over surrounding terrain; signal frequency; timing limitations, i.e. 35 km for 3G/4G ; transmitter/receiver power; weather conditions; data rate reflection and absorption of the radio energy by obstacles; and noise sources, including other mobile devices in the immediate area or between the individual mobile device and the cellular tower.

In high-population urban areas where communication traffic can be saturated, service providers tend to add more cells and reduce broadcast power in order to restrict range to as little as 0.1 miles. Here, increasing handset signal strength will ironically decrease overall system performance. In rural areas, service providers tend to broadcast at maximum allowable power to reach larger groups of customers. In rural areas, the problem is not to avoid saturation, but instead to provide enough signal strength to “reach the tower.” In this case, quality of service at a if) given range is dependent on factors such as terrain and weather. Overall, there is need to both extend the range and improve the quality of service.

There is a second distinction between urban and rural cellular communication. In the urban environment, cells surround a user. Thus, at any time, depending on, for example, communication traffic and the temporary presence of a physical obstacle or a noise source, the strongest link can come from any direction. On the other hand, in the rural environment, only one or two cell towers may be within range of the handset, and therefore, the direction to the strongest link is pre-determined. There is need for a transmitting/receiving system that takes advantage of this directionality in order to improve the quality of service.

U.S. carriers have also announced plans to grow their wireless networks. According to the FCC, more than $25 billion in private funding is now spent annually on network improvements. However, by far, the majority of that $25 billion investment is going toward 46 LTE deployments that cover cities, other larger population centers, and major highways.

Service providers carefully position cell phone towers near population centers or major highways in order to reach the maximum number of users while minimizing infrastructure costs. However, some potential remotely located users, for example recreational vehicles, boats, logging or ranching crews or the like, are often at some distance from a cell phone tower, and have limited or no quality of service. In cases such as emergency or security services, it is critically important for users to be able to increase the effective range from a cell phone tower to an individual cell phone. There is a need to extend the range from cell phone towers to provide service to such users.

In addition, battery-powered cellular equipment (e.g., “handsets”) are required to transmit back to the mast even when on standby. For this reason, battery life in remote locations is optimized if most or all the handset's transmitted signal can be directed toward the cell tower's location, as opposed to being spread indiscriminately in all directions. With a directed signal, programming can reduce cell phone broadcast power, or the system can simply tolerate a weak battery without loss of service.

Several reasons explain recent growth of the cellular repeater market. First, there is ongoing and large-scale abandonment of landline. Second, wireless network coverage is poor or intermittent in many areas. Third, low population density areas do not currently have service. Fourth, there is a need to provide security, emergency, and recreational Internet service outside the normal range of existing or planned cell phone towers. With weak cellular coverage, the repeater system was necessary because the portable equipment could only transpond on the cellular hand, and possible because low data rates were tolerant of delay, or latency, e.g. between message packets. The repeater system is no longer viable in a 4G/LTE system because the interconnections of wireless links are latency sensitive. Fortunately, the repeater system is no longer necessary because portable equipment can transpond on other bands, for example Wi-Fi. There is a need for a system that provides function similar to a cellular repeater, but is flexible to input (output) a signal from a distant source, and output (input) a signal locally that includes the information received (transmitted) from the distant source.

Historically, antenna systems have typically been based on “Yagi” or log-periodic arrays. In order to develop enough gain, these essentially one-dimensional arrays must be up to a meter in length. In order to cover the entire set available of LIT frequency bands more than one antenna may be necessary. With more than one linear array, installations are complicated and unwieldy. There is a need for a simple antenna system having a compact design with dimensions much less than 1 meter.

With any wireless network, a key security concern is the possibility of unauthorized access to data being sent and received over the wireless network. A signal that is directed towards the intended target and limits transmission in other directions is desirable, since it makes it more difficult for eavesdroppers to receive sufficient signal strength to accurately intercept transmissions. There is a need for a wireless network system having improved security against eavesdroppers.

To ensure proper functionality, radio antennas must maintain their designed shape and directional positioning. However, wind forces can load the antenna and cause it to distort or otherwise lose its shape, aim and position. There is a need for a radio antenna that has minimal susceptibility to change in response to environmental forces and other external forces.

In addition, proper functionality of radio antennas can be degraded from interference due to thermal radiation, and from signals traveling along the ground and reflected by the ground. There is a need for a radio antenna that has minimal susceptibility to interference from thermal radiation, or from ground-based signals.

Antenna feeds and connections can cause undesired Ohmic losses, high receiver noise temperatures, spillover, and the excitation of unwanted frequency modes. There is a need for a system that tolerates placement of transceiver devices and supporting electronics such as amplifiers near an antenna without interrupting the signal or otherwise causing interference.

Systems termed “mobile hot spots” are presently commercially available. Indeed, man smart phones can be configured to function as a mobile hot spot. Mobile hot spots include capability to receive (transmit) radio frequency (RF) electromagnetic waves having a carrier frequency and encoded information; to demodulate a carrier wave as appropriate to extract the encoded information and to modulate a carrier wave as appropriate to include the encoded information; and an antenna to wirelessly transmit (receive) a second carrier wave including the information.

Available mobile hot spots are designed to receive a signal from a remote source such as a cellular tower, and to locally transmit, for example, Some available mobile hot spots include an option for an external antenna connection, in order to improve locally transmitted signal strength. An implicit assumption with all mobile hot spots is that a sufficiently strong signal can be received from (transmitted to) a remote site, either from a cellular tower, cable modem, or the like. There is a need for a system including a mobile hot spot that is operable with a weak signal received from (transmitted to) a remote site.

At 1.0 GHz, signal loss due to 50-Ohm coax cable ranges from about 4.5-32 dB per 100 feet, depending on the cost and quality of the cable. In addition, loss per coaxial connection can be 1/4 dB or more. There is a need for a transmit/receive system that minimizes losses due to coax cables and connections.

### BRIEF SUMMARY OF THE INVENTION

In one embodiment, the present invention is a system comprising a directive (“high-gain”) antenna to receive (transmit) a first, low signal strength, radio frequency (RF), electromagnetic waves having a carrier frequency and encoded information; an electronic circuit to demodulate a carrier wave as appropriate to extract the encoded information and to modulate a carrier wave as appropriate to include the encoded information; and an antenna to wirelessly transmit (receive) a second carrier wave including the information. The system is housed in a compact, weather-resistant radome, and optionally includes a power source, which may be one or more of batteries, battery chargers, and power connections. The feed point of the high-gain antenna allows direct connection of a 4G LTE digital radio to the antenna.

In a preferred embodiment, the second carrier wave that is transmitted (received) may be Wi-Fi, Bluetooth, or another similar band. For reference, Table One below lists unlicensed bands of interest.

TABLE ONE
Unlicensed bands

| Country | Frequency | | Notes | Standard |
|---|---|---|---|---|
| US | 2,400-2,483.5 | GHz | ISM Band (max 4 W | 802.11/11 |
| | | | EIRP) | |
| | 902-928 | MHz | ISM Band (Used by GSM | |
| | | | in most countries) | |
| | 5,800-5,925 | GHz | ISM Band | |
| | 5.15-5.25 | GHz | UNII (Unlicensed - | 802.11a |
| | | | National Information | |
| | | | Infrastructure) max. | |
| | | | 200 mw EIRP | |
| | 5.25-5.35 | GHz | UNII max, 1 w EIRP | 802.11a |
| | 5,725-5,825 | GHz | UNII max, 4 w EIRP | 802.11a |

For example, a Wi-Fi signal occupies live channels in the 2.4 GHz band. However, Wi-Fi networks have limited range. For example, an 802.11b or 802.11g wireless access point with a stock antenna might have an indoor range of 35 m (120 ft) and outdoor range of 100 in (300 ft). it is possible to improve range by fitting a wireless router with detachable antenna with an upgraded antenna having higher gain.

In another embodiment, the present invention provides a broadband, high-gain, bi-directional, double-ridged guide horn (DRGH) antenna capable of boosting the strength of the transmitted/received signal by at least 3 dB, but preferably by 7 dB or more. With the system, losses due to cabling are virtually eliminated, since A) a very short (˜0.01-0.1 meter long) RF connection is made between the high-gain antenna and the transmitter/receiver circuitry; and B) all connections are made wirelessly, with the exception of power connections. The system of the present invention comprises a DRGH optimized to provide good transmit and receive performance over the range of about 0.7 GHz-2.5 GHz, while being compact and low cost. Since the DRGH may be enclosed in a radome, construction may be, for example, from an inexpensive, thin-walled aluminum sheet.

In a further embodiment of the present invention, the system includes a monopole antenna for transmitting (receiving) the second carrier wave such as Wi-Fi, Bluetooth, or another similar band. For broad, unobstructed coverage, the monopole antenna is located beneath the DRGH. The bottom surface of the DRGH may act as a ground plane for the enclosed monopole antenna.

In another embodiment, the present invention provides a transmitter/receiver function provided by a commercially available “'mobile hot spot” having a 4G-capable external antenna connection. The mobile hot spot may include capability for software programming to enable customization for user preferences. For example, the Sierra Wireless Elevate 4G mobile hot spot includes capability for an external antenna connection.

In one preferred embodiment of the system, a weather-resistant radome is mounted on a mast. Included in the radome are a high-gain DRGH integrated with a commercially available mobile hot spot including a Wi-Fi transmitter, and as battery. A power cable is connected to the battery within the radome and extends to a remote power source. The system performs bi-directional communication with an available cell phone tower, thereby providing connection to the Internet. The system typically provides high quality of service at as distance of at least 3 times farther from that of a cell phone tower. The system also performs bi-directional communication with one or more nearby devices.

In yet another embodiment, the present invention provides a weather-resistant housing, which may be a radome, mounted on a system that is in motion. Included in the radome is as high-gain DRGH mounted on a rotary mount; a single commercially available mobile hot spot; a Wi-Fi transmitter; a battery and a battery charger; a stepper motor operably connected to rotate the antenna mount; and drive circuitry for the stepper motor. A power cable is connected to the battery charger within the radome and extends to a remote power source. Tracking circuitry is also included inside the radome to instantaneously determine the direction of the strongest signal as the stepper motor rotates. Execution of an algorithm to determine strongest signal direction can be activated on demand. The system performs bi-directional communication with an available cell phone tower, thereby providing connection to the Internet, The system may provide a high quality of service at a distance of at least 3 times farther than that of a cell phone tower.

In yet another embodiment, a weather-resistant radome is mounted on a system that is in motion. Included in the radome are two high-gain DRGHs; a single commercially available mobile hot spot; a Wi-Fi transmitter; a battery and a battery charger. A power cable is connected to the battery charger within the radome and extends to a remote power source. Tracking circuitry is also included in the radome to instantaneously determine the direction of the strongest signal. The system performs bi-directional communication with an available cell phone tower, thereby providing connection to the Internet.

In an additional preferred embodiment of the system, a weather-resistant radome is mounted on a mast. Included in the radome is a high-gain DRGH integrated with a mobile hot spot including a Wi-Fi transmitter. A solar cell array is mounted on the top surface of the radome, and is connected to it power management system within the radome to act as a battery charger, thereby providing electrical power on demand. The system performs bi-directional communication with an available cell phone tower, thereby providing connection to the Internet. The system also performs bi-direction communication with one or more nearby devices, making use of an available band. The top surface of a cylindrical radome is ideally suited for mounting a solar cell array. Commercially available solar cells having installed cost of $1-2/watt output roughly 10-20 Watt/m². With, for example, a radome having top surface area of 0.3 m² and an output averaging 10 Watt/m² over a five-hour period each day, about 15 Watt-hr are produced each day. With a 9.0 volt, 2000 mA battery, the storage capacity is 18 Watt-hr. For example, a mobile hot spot might consume less than about 1-2 Watt when transmitting (receiving), Therefore, a solar cell array covering the top surface of the radome is well matched for charging, the internal battery when the system is active for roughly eight hours per day.

In another embodiment, the present invention provides a high gain antenna such as a log periodic dipole array enclosed in a radome, a separate weather resistant enclosure containing the elements of a mobile hotspot and the elements of as power supply, RF cables connecting the high gain antenna to the mobile hotspot elements, one or more Wi-Fi antennas with RF cables connecting the mobile hotspot to the Wi-Fi antennas, and a cable or other means tor charging the power supply.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 is a schematic of a prior art cellular repeater system with Yagi or log-periodic antenna.

FIG. 2 is an illustration of a system including cellular tower, highly directional style antenna to receive from and transmit to the cellular tower, a mobile hot spot, and an omni-directional antenna.

FIGS. 3A and 3B illustrate the limitation on range between a fixed cellular node 307 and a mobile hotspot 301 due to latency effects.

FIG. 4A is a top view of a double-ridged guide horn antenna (DRGH).

FIG. 4B is a front view of a double-ridged guide horn antenna (DRGH).

FIG. 4C is an isometric a view of a double-ridged guide horn antenna (DRGH).

FIG. 4D is side view of a double-ridged guide horn antenna (DRGH).

FIG. 5 is an illustration of a DRGH, mobile hot spot, and power source enclosed in a radome.

FIG. 6 is an illustration of a DRGH on a rotary mount, a mobile hot spot, a stepper motor for automating rotation, and a power source enclosed in radome.

FIG. 7 is an illustration of two DRGH, a mobile hot spot, a switch configurable to select between two DRGH, and a power source enclosed in a radome.

FIG. 8 is an illustration of a high gain antenna such as a log periodic dipole array contained in a radome and it separate weather resistant enclosure containing the elements of a mobile hotspot, the elements of a power supply and several Wi-Fi antennas.

### DETAILED DESCRIPTION OF THE INVENTION

Detailed embodiments of the present invention are disclosed herein; however, it is to be understood that the disclosed embodiments are merely exemplary of the invention, which may be embodied in various terms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.mm.

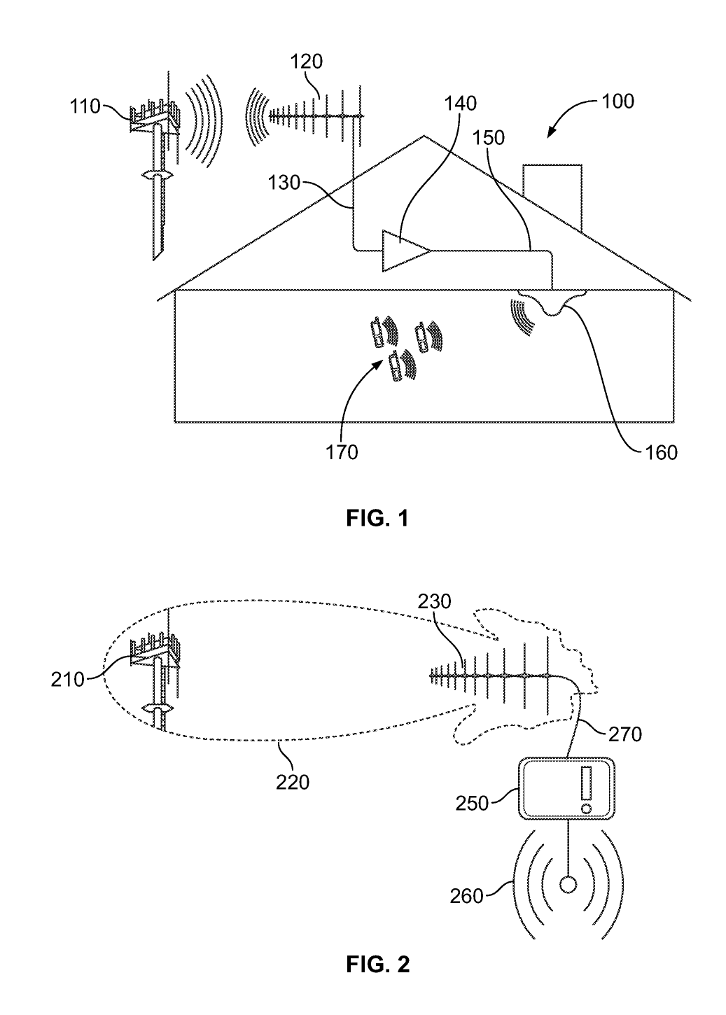

A prior cellular repeater system 100 is illustrated in FIG. 1. Yagi-style antenna 120 transmits and receives a signal to and from distance cellular tower 110. Received signals are connected to amplifier 140 via coax cable 130. Amplified signals are connected to omni-directional antenna 160 via coax cable 150. Omni-directional antenna 160 transmits and receives signals from one or more individual devices 170. Issues with the prior art system include the fact that it is awkward to connect Yagi-style antenna 120 directly to wireless equipment, and that losses in signal strength occur along coax cables 130 and 150, as well as necessary connectors (not shown).

FIG. 2 shows how a conventional system may be modified to include a remote cellular tower 210, highly directional Yagi-style antenna 230 to receive from and transmit to the cellular tower, a mobile hot spot 250, and omni-directional antenna 260. Radiation pattern 220 is directional, thereby meeting the requirements for high gain. However, Yagi-style antenna 230 has an elongated shape. Therefore, it is awkward to connect such a Yagi-style antenna 230 directly to mobile equipment. The Yagi-style antenna 230 is mounted outdoors and connected to the mobile hotspot 250, which is indoor by means of a radio frequency transmission line 270. This transmission line, typically coaxial cable, adds loss and delay to the received and transmitted cellular signal. The cable losses may be overcome by adding an amplifier, which typically adds more delay. It is the delay for latency) that hampers the system for 4G/LTE.

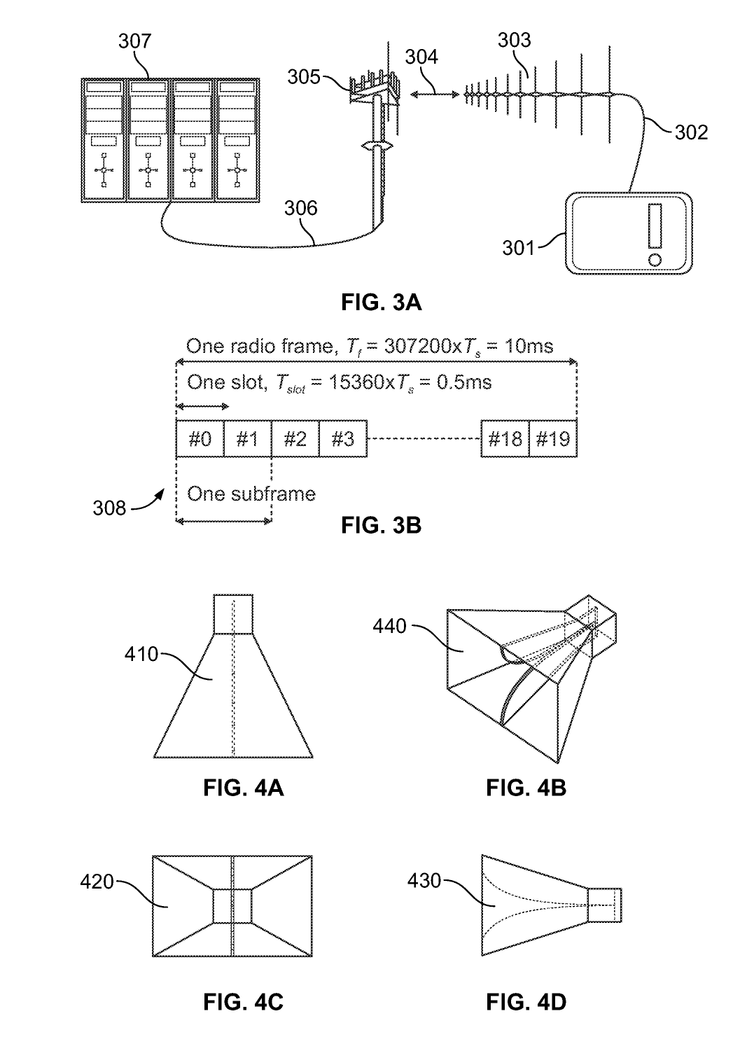

FIGS. 3A and 3B illustrate the limitation on range between a fixed cellular node 307 and a mobile hotspot 301 due to latency effects. LTE system design allows for a 20 milliseconds (msec) round-trip between fixed cellular node 307 and mobile hotspot 301. However, the one-way time lapse from mobile hotspot 301 to fixed cellular antenna 305 is limited to only 0.117 msec. This is illustrated in chart 308 of FIG. 3.8. The minimum time slot of the LTE radio frame is 0.5 msec, and any delay from mobile hotspot 301 to fixed cellular antenna 305 longer than approximately 25% of the 0.5 msec minimum time slot would render communication attempts unintelligible. The maximum free space propagation distance 304 from fixed cellular antenna 305 to mobile antenna 303 is thus set at 35 km. This maximum free space propagation distance 304 does not allow fir any latency to be contributed by mobile antenna 303, mobile hotspot 301 or RF connection path 302 between mobile antenna 303 and mobile hotspot 301. Any additional latency in the signal path that makes the total latency greater than the allowable 0.117 msec will break the wireless link. Obviously, mobile antenna 303 and mobile hotspot 301 are required. However, reducing the length of RF interconnection path 302 can shorten the latency. In addition, reducing length of RF interconnection path 302 eliminates the need for transmit/receive amplification to overcome RF signal path loss.

The present invention provides a system comprised of a first bi-directional antenna having high-gain and highly-directional characteristics operably coupled to a transceiver capable of at least demodulation, modulation, and amplification; a second omni-directional antenna operably coupled to said transceiver; an electrical power source operably coupled to said transceiver; and RF interconnections between said transceiver and said first bi-directional antenna and between said transceiver and said second omni-directional antenna. In addition, the antenna may be a double-ridged guide horn having minimum gain of 7 dB over the frequency range of 0.7 gigahertz to 2.5 gigahertz. The system reduces the round-trip communication latency between said remote cellular tower and first and second distant communicators to less than 2.0 milliseconds with a distance of 35 kilometers between said remote cellular tower and said communicators.

FIGS. 4A-4D show the design of a double-ridged guide horn antenna 410 (DRGH). DRGH antenna 410 has a high gain in the range of 700-2700 MHz. DRGH 410 is also designed to fit within a radome.

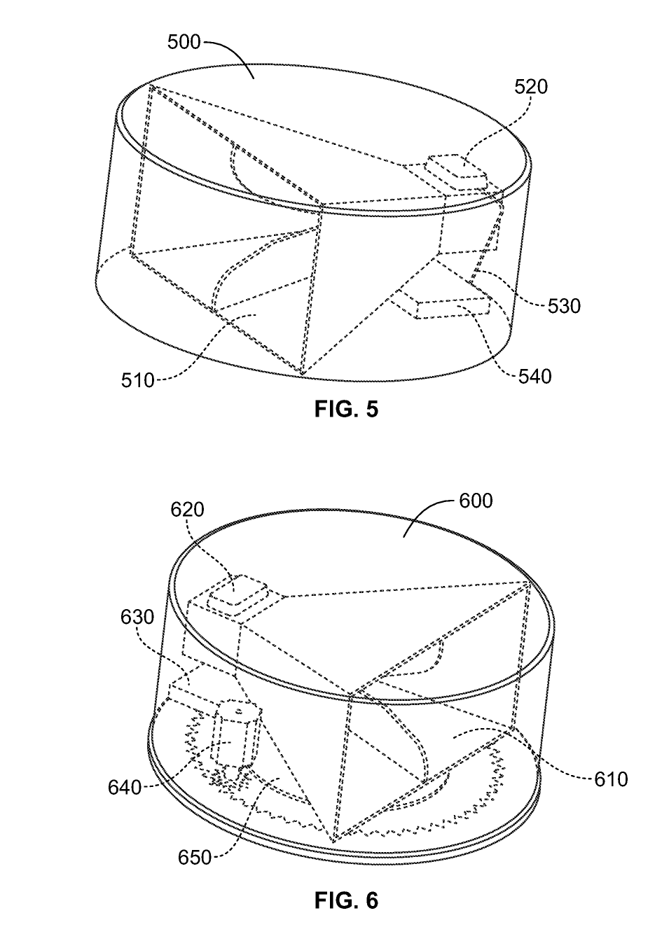

FIG. 5 is an illustration of an embodiment of the present invention comprising a DRGH 510, mobile hot spot 520, power cable 530, and power source 540 enclosed in radome 500. An exemplary radome may be cylindrical, with major dimensions of less than about 0.6 meters (24 inches). For example, the diameter of the radome 500 may be about 0.5 meters (19.7 inches), while the height is about 0.25 meters (10 inches).

FIG. 6 to shows another embodiment of the present invention comprising DRGH 610 on as rotary mount 650, mobile hot spot 620, stepper motor 640 for forcing rotation, and power source 630 enclosed in radome 600. When stepper motor 640 is energized, the enclosed components can rotate freely. An optional control circuit (not shown) can be included to start rotation on demand and to halt rotation when the amplitude of a received signal reaches a predetermined threshold or is maximized.

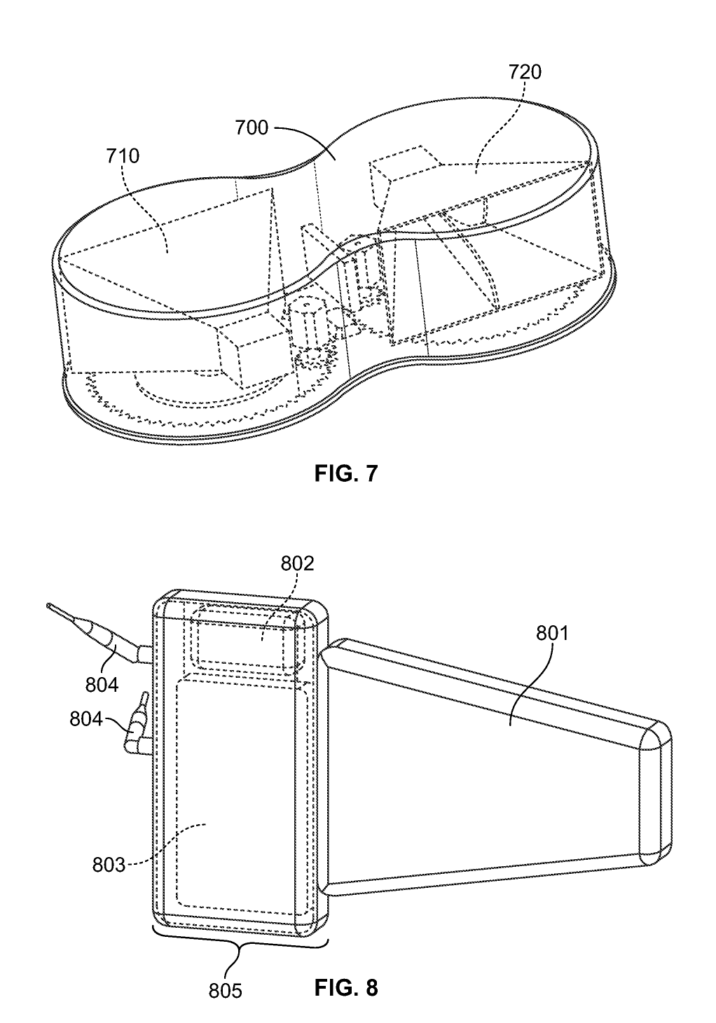

FIG. 7 shows yet another embodiment of the present invention comprising first DRGH 710 and second DRGH 720 enclosed in radome 700. It is understood that the system may further include a mobile hot spot, a switch configurable to select between two DRGH, and a power source. The direction of maximum signal strength for first DRGH 710 and second DRGH 720 may be about 180 degrees apart.

FIG. 8 illustrates yet another embodiment of the present invention comprising a 4G/LTE high gain antenna such as a log periodic dipole array enclosed in radome 801 with a second weather resistant enclosure 805 disposed in close proximity. The second weather resistant enclosure contains the elements of a wireless hotspot 802, a power supply 803, several Wi-Fi antennas 804, means to connect the high gain antenna to the elements of the wireless hotspot means to connect the Wi-Fi antennas to the elements of the mobile hotspot and a means to charge the power supply. The charging means could be a power cable or a photovoltaic array. The RF connection from the high gain antenna to the elements of the hotspot is short, less than 0.6 meter. The connecting means and charging means are omitted from this figure.

In another embodiment, the present invention provides a system having a first bi-directional antenna that is operably coupled to a transceiver capable of at least demodulation, modulation, and amplification. The device also has a second omni-directional antenna operably coupled to a transceiver as well as an electrical power source operably coupled to the transceiver. RF interconnections are also provided between the transceiver, the first bi-directional antenna, the transceiver and the second-directional antenna. The first bi-directional antenna transmits and receives a first carrier frequency, while the second omni-directional antenna transmits and receives a second carrier frequency. The components may be also housed in a weather-resistant housing wherein each of the major dimensions of the housing may be less than 0.6 meter in length. The length of the RF interconnection between the transceiver and the first bi-directional antenna is less than 0.1 meters and the length of the RF interconnection between the transceiver and the second omni-directional antenna is less than 0.1 meters. The first bi-directional antenna may be a guide horn that is a double-ridged guide horn having minimum gain of 7 dB over the frequency range of 0.7 gigahertz to 2.5 gigahertz.

The double-ridged guide horn antenna is preferably aimed in a predetermined direction to maximize power received from and directed to a remote cellular tower. Preferably the round-trip communication latency is less than 2.0 milliseconds. The system of claim 1 wherein said first bi-directional antenna is movable to increase the received signal strength. A second bi-directional antenna also be used. One or more of the antennas may be movable to increase the received signal strength.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. A mobile hotspot system comprising:
a first bi-directional antenna operably coupled to a transceiver capable of at least demodulation, modulation, and amplification;
a second omni-directional antenna operably coupled to said transceiver;
an electrical power source operably coupled to said transceiver; and
RF interconnections between said transceiver, said first bi-directional antenna, said transceiver and said second-directional antenna.

2. The system of claim 1 wherein said first bi-directional antenna transmits and receives a first carrier frequency, while said second omni-directional antenna transmits and receives a second carrier frequency.

3. The system of claim 2 wherein said system is housed weather-resistant housing.

4. The system of claim 3 wherein each of the major dimensions of said housing is less than 0.6 meter in length.

5. The system of claim 4 wherein the length of said RF interconnection between said transceiver and said first bi-directional antenna is less than 0.1 meters and the length of said RF interconnection between said transceiver and said second omni-directional antenna is less than 0.1 meters.

6. The system of claim 1 wherein said first bi-directional antenna is a guide horn.

7. The system of claim 1 wherein said bi-directional antenna is a double-ridged guide horn having minimum gain of 7 dB over the frequency range of 0.7 gigahertz to 2.5 gigahertz.

8. The system of claim 1 wherein said first bi-directional antenna is a double-ridged guide horn antenna.

9. The system of claim 7 wherein said double-ridged guide horn antenna is aimed in a predetermined direction to maximize power received from and directed to a remote cellular tower.

10. The system of claim 1 wherein the round-trip communication latency is less than 2.0 milliseconds.

11. The system of claim 1 wherein said electrical power source is a solar array mounted atop said housing and operably connected to said transceiver.

12. The system of claim 1 wherein said first bi-directional antenna is a Yagi-style antenna.

13. The system of claim 1 wherein said first bi-directional antenna is a log-periodic antenna.

14. The system of claim 1 wherein said first bi-directional antenna is movable to increase the received signal strength.

15. The system of claim 1 further including a second bi-directional antenna.

16. The system of claim 15 wherein said second bi-directional antenna is movable to increase the received signal strength.

17. The system of claim 1 wherein said first bi-directional antenna is movable to increase the received signal strength and further including a second bi-directional antenna, said second antenna is movable to increase the received signal strength.

18. A mobile hotspot system comprising:
a first bi-directional antenna operably coupled to a transceiver capable of at least demodulation, modulation, and amplification, said first bi-directional antenna transmits and receives a first carrier frequency;
a second omni-directional antenna operably coupled to said transceiver, said second omni-directional antenna transmits and receives a second carrier frequency; an electrical power source operably coupled to said transceiver; and
RF interconnections between said transceiver, said first bi-directional antenna, said transceiver and said second-directional antenna.

19. The system of claim 18 wherein the length of said RF interconnection between said transceiver and said first bi-directional antenna is less than 0.1 meters and the length of said RE interconnection between said transceiver and said second omni-directional antenna is less than 0.1 meters.

20. The system of claim 18 wherein the round-trip communication latency is less than 2.0 milliseconds.
